(19) United States
(12) Patent Application Publication
(10) Pub. No.: US 2023/0054122 A1
(43) Pub. Date: Feb. 23, 2023

(54) Electrolyte Solution for Lithium Secondary Battery and Lithium Secondary Battery Including the Same

(71) Applicant: SK ON CO., LTD., Seoul (KR)

(72) Inventors: Jin Hong Lee, Daejeon (KR); Yu Na Shim, Daejeon (KR); In Haeng Cho, Daejeon (KR); Su Hee Han, Daejeon (KR)

(21) Appl. No.: 17/863,769

(22) Filed: Jul. 13, 2022

(30) Foreign Application Priority Data
Jul. 14, 2021 (KR) 10-2021-0091982

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569; H01M 2300/0037

(57) ABSTRACT

An electrolyte solution for a lithium secondary battery includes a lithium salt, an organic solvent, a first additive including a lactone-based compound represented by a specific chemical formula, and a second additive including a fluorine-containing phosphate-based compound, a fluorine-containing carbonate-based compound, a sultone-based compound and a sulfate-based compound. A lithium secondary battery including the electrolyte solution is also provided.

### CROSS-REFERENCE TO RELATED APPLICATION

This application claims priority to Korean Patent Application No. 10-2021-0091982 filed Jul. 14, 2021, the disclosure of which is hereby incorporated by reference in its entirety.

### BACKGROUND OF THE INVENTION

### 1. Field of the Invention

The present invention relates to an electrolyte solution for a lithium secondary battery and a lithium secondary battery including the same. More particularly, the present invention relates to an electrolyte solution for a lithium secondary battery including an organic solvent, a lithium salt and an additive, and a lithium secondary battery including the same.

### 2. Description of the Related Art

A secondary battery which can be charged and discharged repeatedly has been widely employed as a power source of a mobile electronic device such as a camcorder, a mobile phone, a laptop computer.

A lithium secondary battery is highlighted and developed among various types of secondary batteries due to high operational voltage and energy density per unit weight, a high charging rate, a compact dimension, etc.

For example, the lithium secondary battery may include an electrode assembly including a cathode, an anode and a separation layer, and an electrolyte solution immersing the electrode assembly.

For example, the cathode may include a lithium metal oxide capable of reversibly intercalating and de-intercalating lithium as a cathode active material.

During repeated charging and discharging of the lithium secondary battery, structural deformation of the lithium metal oxide, side reactions of the electrolyte, etc., may occur. Accordingly, life-span properties (e.g., a capacity retention) of the lithium secondary battery may be deteriorated.

The lithium secondary battery may be exposed to a high-temperature environment during the repeated charging and discharging or an overcharging. In this case, a battery expansion (a gas generation from an inside of the battery, an increase of a battery thickness), an increase of an internal resistance, a degradation of the life-span properties, etc., may be accelerated in the battery.

### SUMMARY OF THE INVENTION

According to an aspect of the present invention, there is provided an electrolyte solution for a lithium secondary battery having improved high-temperature stability.

According to an aspect of the present invention, there is provided a lithium secondary battery having improved high-temperature stability.

An electrolyte solution for a lithium secondary battery according to exemplary embodiments includes a lithium salt, an organic solvent, a first additive comprising a lactone-based compound represented by Chemical Formula 1, and a second additive including a fluorine-containing phosphate-based compound, a fluorine-containing carbonate-based compound, a sultone-based compound and a sulfate-based compound.

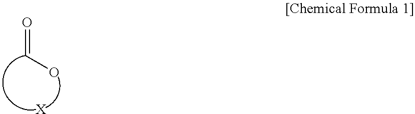

In Chemical Formula 1, X is a substituted or unsubstituted C2-C5 alkylene group.

In some embodiments, the lactone-based compound may include γ-butyrolactone.

In some embodiments, the first additive may be included in an amount from 0.1 wt % to 10 wt % based on a total weight of the electrolyte solution.

In some embodiments, the second additive may be included in an amount from 0.1 wt % to 10 wt % based on a total weight of the electrolyte solution.

In some embodiments, a ratio of a weight of the second additive relative to a weight of the first additive in the electrolyte solution may be from 1 to 10.

In some embodiments, the first additive may be included in an amount from 0.5 wt % to 3.5 wt % based on a total weight of the electrolyte solution. The second additive may be included in an amount from 1 wt % to 5 wt % based on the total weight of the electrolyte solution. A ratio of a weight of the second additive relative to a weight of the first additive in the electrolyte solution may be from 1.25 to 7.

In some embodiments, the fluorine-containing carbonate-based compound may have a cyclic structure.

In some embodiments, the sultone-based compound may include an alkyl sultone-based compound and an alkenyl sultone-based compound.

In some embodiments, the sulfate-based compound may have a cyclic structure.

In some embodiments, the fluorine-containing phosphate-based compound may be included in an amount from 0.1 wt % to 1.5 wt % based on a total weight of the electrolyte solution. The fluorine-containing carbonate-based compound may be included in an amount from 0.1 wt % to 1.5 wt % based on the total weight of the electrolyte solution. The sultone-based compound may be included in an amount from 0.1 wt % to 2 wt % based on the total weight of the electrolyte solution. The sulfate-based compound is included in an amount of 0.1 to 0.5% by weight based on the total weight of the electrolyte, an electrolyte for a lithium secondary battery:

In some embodiments, the organic solvent may include a cyclic carbonate-based solvent and a linear carbonate-based solvent.

A lithium secondary battery according to exemplary embodiments includes a cathode, an anode facing the cathode, and the electrolyte solution for a lithium secondary battery of embodiments as described above.

High-temperature stability of a lithium secondary battery may be improved by using an electrolyte solution for a lithium secondary battery according to exemplary embodiments. For example, an increase of a battery thickness and a resistance in a high-temperature environment may be suppressed, and a capacity retention may be improved.

### BRIEF DESCRIPTION OF THE DRAWINGS

FIG. 1 is a schematic top planar view illustrating a lithium secondary battery in accordance with exemplary embodiments.

FIG. 2 is a schematic cross-sectional view illustrating a lithium secondary battery in accordance with exemplary embodiments.

### DESCRIPTION OF THE INVENTION

According to example embodiments of the present invention, an electrolyte solution a lithium secondary battery including an additive of a predetermined chemical structure is provided. According to exemplary embodiments of the present invention, a lithium secondary battery including the electrolyte solution is also provided.

Hereinafter, the present invention will be described in detail with reference to examples and the accompanying drawings. However, those skilled in the art will appreciate that such embodiments described with reference to the examples and the drawings are provided to further understand the spirit of the present invention and do not limit subject matters to be protected as disclosed in the detailed description and appended claims.

The term “A-based compound” used herein may refer to a compound including a moiety expressed by “A” as a backbone or a substituent.

The term “Ca-Cb” used herein may indicate that the number of carbon atoms is from a to b.

The term “5-7 membered” used herein may indicate that the number of atoms forming a ring structure is from 5 to 7.

<Electrolyte Solution for Lithium Secondary Battery>

An electrolyte solution for a lithium secondary battery (hereinafter, that may be abbreviated as an electrolyte solution) according to exemplary embodiments may include an organic solvent, a lithium salt and an additive.

In an embodiment, the additive may include a lactone-based compound.

In an embodiment, the additive may include a first additive including a lactone-based compound, and a second additive including a fluorine-containing phosphate-based compound, a fluorine-containing carbonate-based compound, a sultone-based compound and a sulfate-based compound.

The electrolyte solution for a lithium secondary battery according to exemplary embodiments may include the first and second additives, and may improve high-temperature stability of the lithium secondary battery. For example, an increase of a battery thickness and a resistance in a high-temperature environment may be suppressed to improve a capacity retention.

The first additive may include a lactone-based compound as represented by Chemical Formula 1 below.

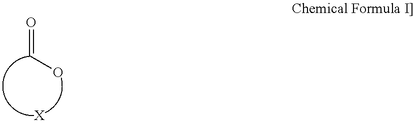

In Chemical Formula 1, X may be a substituted or unsubstituted C2-C5 alkylene group.

For example, a carbon atom of a C═O bond and an oxygen atom of a C—O bond may be connected by the alkylene group to form a 4-7 membered ring.

For example, the alkylene group may refer to a form in which one hydrogen atom is separated from both terminal carbon atoms of an alkane (—CₙH₂ₙ—). For example, —CH₂—CH₂—CH₂— may indicate a propylene group.

For example, “substituted” may refer to a case that a substituent may be further bonded to a carbon atom of the alkylene group by replacing a hydrogen atom of the alkylene group with the substituent. For example, the substituent may be halogen, a C1-C6 alkyl group, a C2-C6 alkenyl group, an amino group, a C1-C6 alkoxy group, a C3-C7 cycloalkyl group or a 5-7 membered heterocycloalkyl group. These may be included alone or in a combination of two or more therefrom.

In some embodiments, the substituent may be a halogen or a C1-C6 alkyl group.

In an embodiment, X may be a substituted or unsubstituted propylene group.

In an embodiment, X may be an unsubstituted propylene group. For example, the lactone-based compound may include gamma-butyrolactone (GBL; γ-butyrolactone).

For example, the lactone-based compound may form a robust solid electrolyte interphase (SEI) on an anode when being combined with the additives to be described later so that decomposition of the organic solvent (e.g., EC, EMC, etc.) may be effectively prevented. Thus, a gas generation and the increase of the battery thickness may be remarkably reduced.

In an embodiment, the first additive may be included in an amount from 0.1 weight percent (wt %) to 10 wt %, from 0.25 wt % to 5 wt %, or from 0.5 wt % to 3.5 wt % based on a total weight of the electrolyte solution. In the above range, a lithium secondary battery having more improved high-temperature storage properties may be obtained.

The electrolyte solution for a lithium secondary battery according to exemplary embodiments may further include the second additive including the fluorine-containing phosphate-based compound, the fluorine-containing carbonate-based compound, the sultone-based compound, and the sulfate-based compound together with the above-described first additive.

In an embodiment, the second additive may be included in an amount from 0.1 wt % to 10 wt %, or from 1 wt % to 5 wt % based on the total weight of the electrolyte solution. In the above range, a lithium secondary battery having more improved high-temperature storage properties may be obtained.

In an embodiment, a ratio of a weight of the second additive relative to a weight of the first additive in the electrolyte solution may be in a range from 1 to 10, more than 1 and 10 or less, from 1.25 to 10, or from 1.25 to 7. In the above ratio, the lithium secondary battery having more improved high-temperature storage properties may be obtained.

In some embodiments, the first additive may be included in an amount from 0.5 wt % to 3.5 wt % based on the total weight of the electrolyte solution, and the second additive may be included in an amount from 1 wt % to 5 wt % based on the total weight of the electrolyte solution. The ratio of the weight of the second additive relative to the weight of the first additive in the electrolyte solution may be from 1.25 to 7. In the above range, the lithium secondary battery having enhanced capacity retention ratio while preventing an increase of resistance and battery thickness in a high temperature environment may be achieved.

For example, the fluorine-containing phosphate-based compound may include a fluorine (F) atom directly bonded to a phosphorus (P) atom or an alkyl group (e.g., —CF₃) to which a fluorine atom is bonded.

In an embodiment, the fluorine-containing phosphate-based compound may be a fluorine-containing lithium phosphate-based compound that may be represented by the following Chemical Formula 2.

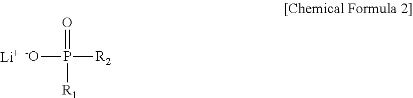

In Chemical Formula 2, R₁ and R₂ may each be independently halogen or a substituted or unsubstituted C1-C6 alkyl group, and at least one of R₁ and R₂ may be F.

In some embodiments, the fluorine-containing phosphate-based compound may include at least one of lithium difluorophosphate (LiPO₂F₂), lithium tetrafluorooxalate phosphate and lithium difluoro(bisoxalato)phosphate.

In an embodiment, the fluorine-containing phosphate-based compound may be included in an amount from 0.1 wt % to 2 wt %, from 0.1 wt % to 1.5 wt %, from 0.1 wt % to 1 wt %, or from 0.1 wt % to 0.5 wt % based on the total weight of the electrolyte solution.

For example, the fluorine-containing carbonate-based compound may include a fluorine (F) atom directly bonded to at least one carbon (C) atom, or may include an alkyl group to which a fluorine atom is bonded.

In an embodiment, the fluorine-containing carbonate-based compound may have a cyclic structure. For example, in the fluorinated carbonate-based compound, at least one atom of a carbonate group may be disposed in a ring. For example, the fluorine-containing carbonate-based compound may have a 5 to 7-membered cyclic structure.

In one embodiment, the fluorine-containing carbonate-based compound may be represented by Chemical Formula 3.

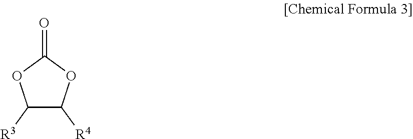

In Chemical Formula 3, R₃ and R₄ may each be independently hydrogen, halogen or a substituted or unsubstituted C1-C6 alkyl group, and at least one of R₃ and R₄ may be F.

In some embodiments, the fluorine-containing carbonate-based compound may include fluoroethylene carbonate (FEC).

In an embodiment, the fluorine-containing carbonate-based compound may be included in an amount from 0.1 wt % to 2 wt %, from 0.1 wt % to 1.5 wt %, from 0.1 wt % to 1 wt %, or from 0.1 wt % to 0.5 wt % based on the total weight of the electrolyte.

In an embodiment, the sultone-based compound may be represented by Chemical Formula 4.

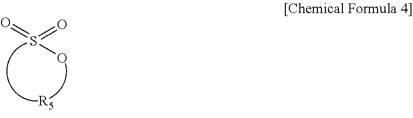

In Chemical Formula 4, R₅ may be a substituted or unsubstituted C2-C5 alkylene group or a substituted or unsubstituted C3-C5 alkenylene group.

In an embodiment, the sultone-based compound may include an alkyl sultone-based compound and/or an alkenyl sultone-based compound.

In an embodiment, the sultone-based compound may include both the alkyl sultone-based compound and the alkenyl sultone-based compound.

For example, the alkyl sultone-based compound may have only a saturated bond in the ring, and the alkenyl sultone-based compound may have an unsaturated bond (e.g., C═C double bond) in the ring.

For example, the alkyl sultone-based compound may include at least one of 1,3-propane sultone (PS) and 1,4-butane sultone.

For example, the alkenyl sultone-based compound may include at least one of ethensultone, 1,3-propene sultone (PRS), 1,4-butene sultone and 1-methyl-1,3-propene sultone. have.

In an embodiment, the sultone-based compound may be included in an amount from 0.1 wt % to 2 wt %, 0.1 wt % to 1.5 wt %, 0.1 wt % to 1 wt % or from 0.1 wt % to 0.5 wt % based on the total weight of the electrolyte solution.

In an embodiment, the sulfate-based compound may have a cyclic structure.

For example, in the sulfate-based compound, at least one atom of a sulfate group may be included in a ring. For example, the sulfate-based compound may have a 5 to 7-membered cyclic structure.

In an embodiment, the sulfate-based compound may be represented by Chemical Formula 5 below.

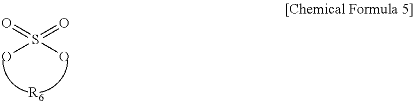

In Chemical Formula 5, R₆ may be a substituted or unsubstituted C2-C5 alkylene group.

For example, the sulfate-based compound may include at least one of ethylene sulfate (ESA), trimethylene sulfate (TMS) and methyltrimethylene sulfate (MTMS).

For example, the sulfate-based compound may be included in an amount from 0.1 wt % to 2 wt %, from 0.1 wt % to 1.5 wt %, from 0.1 wt % to 1 wt % or from 0.1 wt % to 0.5 wt % based on the total weight of the electrolyte solution.

In an embodiment, the electrolyte solution may not include a vinylidene carbonate-based compound. For example, the vinylidene carbonate-based compound may be vinylene carbonate (VC), vinylethylene carbonate (VEC), or the like. In an embodiment, the electrolyte may not contain lithium bis(oxalate)borate (LiBOB). In this case, a high-temperature stability achieved from the combination of the first and second additives may not be degraded.

The organic solvent may include, e.g., an organic compound that may provide a sufficient solubility for the lithium salt and the additive and may not have a reactivity in the battery.

For example, the organic solvent may include a carbonate-based solvent, an ester-based solvent, an ether-based solvent, a ketone-based solvent, an alcohol-based solvent, an aprotic solvent, or the like. These may be used alone or in combination of therefrom.

In an embodiment, the organic solvent may include a carbonate-based solvent.

In some embodiments, the carbonate-based solvent may include a linear carbonate-based solvent and a cyclic carbonate-based solvent.

The linear carbonate-based solvent may include, e.g., at least one of dimethyl carbonate (DMC), ethyl methyl carbonate (EMC), diethyl carbonate (DEC), methyl propyl carbonate, ethyl propyl carbonate and dipropyl carbonate, etc.

For example, the cyclic carbonate-based solvent may include at least one of ethylene carbonate (EC), propylene carbonate (PC) and butylene carbonate, etc.

In some embodiments, in the organic solvent, a volumetric amount of the linear carbonate-based solvent may be greater than that of the cyclic carbonate-based solvent.

For example, a mixing volume ratio of the linear carbonate-based solvent and the cyclic carbonate-based solvent may be from 1:1 to 9:1, preferably from 1.5:1 to 4:1.

The ester-based solvent may include, e.g., at least one of methyl acetate (MA), ethyl acetate (EA), n-propyl acetate (n-PA), 1,1-dimethylethyl acetate (DMEA), methyl propionate (MP) and ethyl propionate (EP).

The ether-based solvent may include, e.g., at least one of dibutyl ether, tetraethylene glycol dimethyl ether (TEGDME), diethylene glycol dimethyl ether (DEGDME), dimethoxyethane, tetrahydrofuran (THF) and 2-methyltetrahydrofuran.

The ketone-based solvent may include, e.g., cyclohexanone.

The alcohol-based solvent may include, e.g., at least one of ethyl alcohol and isopropyl alcohol.

The aprotic solvent may include, e.g., a nitrile-based solvent, an amide-based solvent (e.g., dimethylformamide), a dioxolane-based solvent (e.g., 1,3-dioxolane), a sulfolane-based solvent, etc. These may be used alone or in combination of therefrom.

The electrolyte solution may include the lithium salt, and the lithium salt may be represented by Li⁺X⁻.

The anion (X⁻) of the lithium salt may include, e.g., F⁻, Cl⁻, Br⁻, I⁻, NO₃⁻, N(CN)₂⁻, BF₄⁻, ClO₄⁻, PF₆⁻, SbF₆⁻, AsF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc. These may be used alone or in a combination thereof.

In some embodiments, the lithium salt may include at least one of LiBF₄ and LiPF₆.

In an embodiment, the lithium salt may be included in a concentration from about 0.01 M to about 5 M, preferably from about 0.01 M to 2 M with respect to the organic solvent. Within the above range, a transfer of lithium ions and/or electrons may be promoted during charging and discharging of the lithium secondary battery.

<Lithium Secondary Battery>

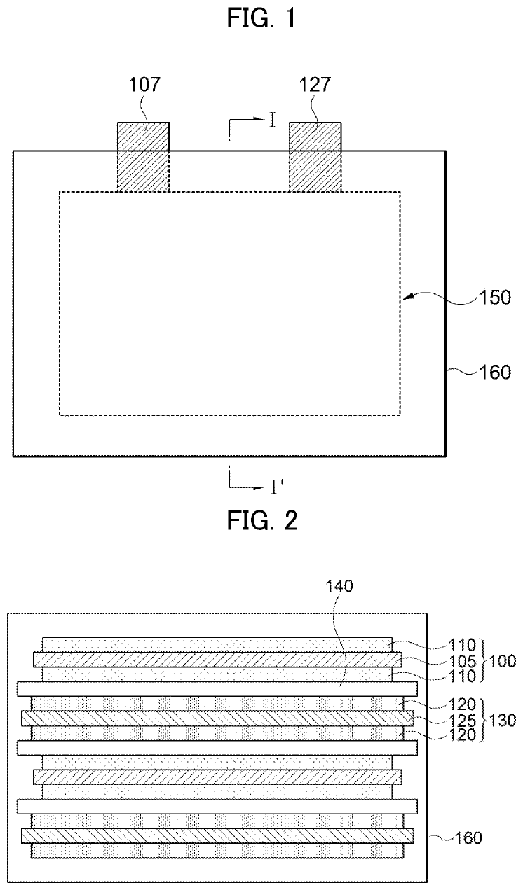

FIGS. 1 and 2 are a schematic top planar view and a schematic cross-sectional view, respectively, illustrating a lithium secondary battery in accordance with exemplary embodiments. Specifically, FIG. 2 is a cross-sectional view taken along line I-I′ of FIG. 1.

Referring to FIGS. 1 and 2, a lithium secondary battery may include an electrode assembly 150 including a cathode 100, an anode 130 and a separation layer 140 interposed between the cathode and the anode. The electrode assembly 150 may be accommodated in a case 160 together with the electrolyte solution according to the above-described exemplary embodiments to be impregnated therein.

The cathode 100 may include a cathode current collector 105 and a cathode active material layer 110 formed on the cathode current collector 105.

For example, the cathode active material layer 110 may include a cathode active material layer and a cathode binder, and may further include a conductive material.

For example, a cathode slurry may be prepared by mixing and stirring the cathode active material in a solvent with the binder, the conductive material, a dispersive agent, etc. The slurry may be coated on the cathode current collector 105, and then dried and pressed to form the cathode 100.

The cathode current collector 105 may include stainless-steel, nickel, aluminum, titanium, copper or an alloy thereof. Preferably, aluminum or an alloy thereof may be used.

The cathode active material may include a lithium metal oxide particle capable of reversibly intercalating and de-intercalating lithium ions.

In an embodiment, the cathode active material may include lithium metal oxide particles including nickel.

In some embodiments, the lithium metal oxide particles may include 83 mol % or more of nickel based on a total number of moles of all elements excluding lithium and oxygen. In this case, a lithium secondary battery having a high capacity may be achieved.

In some embodiments, the lithium metal oxide particles may include 83 mol % or more, 85 mol % or more, 90 mol % or more, or 95 mol % or more of nickel based on the total number of moles of all elements excluding lithium and oxygen.

In some embodiments, the lithium metal oxide particles may further include at least one of cobalt and manganese.

In some embodiments, the lithium metal oxide particles may further include cobalt and manganese. In this case, a lithium secondary battery having improved power and penetration stability.

In an embodiment, the lithium metal oxide particles may be represented by Chemical Formula 7 below.

LiₓNiₐCo_{b}M_{c}O_{y} [Chemical Formula 7]

In Chemical Formula 7, M may be at least one of Al, Zr, Ti, Cr, B, Mg, Mn, Ba, Si, Y, W and Sr, and 0.9≤x≤1.2, 1.9≤y≤2.1, 0.83≤a≤1, 0≤c/(a+b)≤0.13, and 0≤c≤0.11.

In some embodiments, in Chemical Formula 7, 0.85≤a≤1, 0.9≤a≤1, or 0.95≤a≤1.

In some embodiments, in Chemical Formula 7, 0.85≤a≤1, 0.9≤a≤1, or 0.95≤a≤1.

In some embodiments, in Chemical Formula 7, M may be Mn, and 0≤c≤0.17, 0≤c≤0.15, 0≤c≤0.1, or 0≤c≤0.05.

In some embodiments, the lithium metal oxide particle may further include a coating element or a doping element. For example, the coating element or the doping element may include Al, Ti, Ba, Zr, Si, B, Mg, P, Sr, W, La, an alloy thereof or an oxide thereof. These may be used alone or in combination therefrom. The lithium metal oxide particle may be passivated by the coating element or the doping element, so that stability with respect to a penetration by an external object and life-span may be further improved.

The cathode binder may include an organic based binder such as a polyvinylidene fluoride-hexafluoropropylene copolymer (PVDF-co-HFP), polyvinylidenefluoride (PVDF), polyacrylonitrile, polymethylmethacrylate, etc., or an aqueous based binder such as styrene-butadiene rubber (SBR) that may be used with a thickener such as carboxymethyl cellulose (CMC).

The conductive material may include, e.g., a carbon-based material such as graphite, carbon black, graphene, carbon nanotube, etc., and/or a metal-based material such as tin, tin oxide, titanium oxide, a perovskite material such as LaSrCoO₃ or LaSrMnO₃, etc.

The anode 130 may include an anode current collector 125 and an anode active material layer 120 on the anode current collector 125.

The anode active material layer 120 may include an anode active material and an anode binder, and may further include a conductive material.

For example, the anode active material may be mixed and stirred together with the anode binder, the conductive material, etc., in a solvent to form an anode slurry. The anode slurry may be coated on the anode current collector 125, dried and pressed to obtain the anode 130.

For example. the anode current collector 125 may include gold, stainless-steel, nickel, aluminum, titanium, copper or an alloy thereof, preferably, may include copper or a copper alloy.

The anode active material may include a material which may be capable of adsorbing and ejecting lithium ions. The anode active material may include a lithium alloy, a carbon-based material, a silicon-based material, or the like.

For example, the lithium alloy may include a metal element such as aluminum, zinc, bismuth, cadmium, antimony, silicon, lead, tin, gallium, indium, etc.

For example, the carbon-based material may include a crystalline carbon, an amorphous carbon, a carbon composite material, a carbon fiber, etc.

The amorphous carbon may include a hard carbon, cokes, a mesocarbon microbead (MCMB) fired at a temperature of 1500° C. or less, a mesophase pitch-based carbon fiber (MPCF), etc. The crystalline carbon may include an artificial graphite, natural graphite, graphitized cokes, graphitized MCMB, graphitized MPCF, etc.

The silicon-based material may include, e.g., Si, SiOₓ(0<x<2), Si/C, SiO/C, Si-metal, etc. The silicon-based material may be added in the anode active material to implement a high-capacity lithium secondary battery.

For example, a thickness of the battery may be increase during repeated charging and discharging by an expansion of the silicon-based material. The lithium secondary battery according to exemplary embodiments may include the above-described electrolyte solution to reduce or suppress the increase of the battery thickness.

In some embodiments, a content of the silicon-based material in the anode active material may be in a range from 1 wt % to 20 wt %, from 1 wt % to 15 wt %, or from 1 wt % to 10 wt %.

The binder and the conductive material substantially the same as or similar to those mentioned above may also be used in the anode. In some embodiments, the anode binder may include, e.g., an aqueous binder such as styrene-butadiene rubber (SBR), and may be used together with a thickener such as carboxymethyl cellulose (CMC).

The separation layer 140 may be interposed between the cathode 100 and the anode 130. In some embodiments, an area and/or a volume of the anode 130 may be greater than that of the cathode 100. Thus, lithium ions generated from the cathode 100 may be easily transferred to the anode 130 without a loss by, e.g., precipitation or sedimentation.

For example, the separation layer 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, or the like. The separation layer 140 may also include a non-woven fabric formed from a glass fiber with a high melting point, a polyethylene terephthalate fiber, or the like.

For example, an electrode cell may be defined by the cathode 100, the anode 130 and the separation layer 140, and a plurality of the electrode cells may be stacked to form the electrode assembly 150 that may have e.g., a jelly roll shape. For example, the electrode assembly 150 may be formed by winding, laminating or z-folding the separation layer 140.

The electrode assembly 150 may be accommodated together with the electrolyte solution according to exemplary embodiments in the case 160 to define a lithium secondary battery.

As illustrated in FIG. 1, a cathode protrusion and an anode protrusion may be formed from each of the cathode current collector 105 and the anode current collector 125, respectively, in each electrode cell. The cathode protrusions may be merged with each other to form a cathode tab, and the anode protrusions may be merged with each other to form an anode tab.

Electrode tabs including the cathode tab and the anode tab may extend to one end of the case 160. The electrode tabs may be welded together with the one end of the case 160 to be connected to an electrode lead (a cathode lead 107 and an anode lead 127) exposed at an outside of the case 160.

FIG. 2 illustrates that the cathode lead 107 and the anode lead 127 protrude from an upper side of the outer case 160 in a planar view. However, positions of the electrode leads are not specifically limited. For example, the electrode leads may protrude from at least one of lateral sides of the case 160, or may protrude from a lower side of the case 160. Further, the cathode lead 107 and the anode lead 127 may protrude from different sides of the case 160.

The lithium secondary battery may be fabricated into, e.g., a cylindrical shape using a can, a prismatic shape, a pouch shape, a coin shape, etc.

Hereinafter, preferred embodiments are proposed to more concretely describe the present invention. However, the following examples are only given for illustrating the present invention and those skilled in the related art will obviously understand that various alterations and modifications are possible within the scope and spirit of the present invention. Such alterations and modifications are duly included in the appended claims.

### EXAMPLES AND COMPARATIVE EXAMPLES

### Example 1

### (1) Preparation of Electrolyte Solution

1.0 M solution of LiPF₆ (a mixed solvent of EC/EMC in a 25:75 volume ratio) was prepared. A first additive and a second additive were added into the LiPF₆ solution by contents (wt %) as shown in Table 1 below based on a total weight of the electrolyte solution to prepare electrolyte solutions of Examples and Comparative Examples.

### (2) Fabrication of Lithium Secondary Battery Sample

A cathode active material including Li[Ni_{0.6}Co_{0.2}Mn_{0.2}]O₂ and Li[Ni_{0.8}Co_{0.1}Mn_{0.1}]O₂ in a weight ratio of 6:4, a carbon black and polyvinylidene fluoride (PVDF) were mixed in NMP by a weight ratio of 92:5:3 to prepare a cathode slurry.

The cathode slurry was uniformly coated on an area excluding a protrusion of an aluminum foil (thickness: 15 μm) having the protrusion (a cathode tab portion) on one side thereof, and then dried and pressed to form a cathode.

An anode slurry was prepared by mixing an anode active material including artificial graphite and natural graphite in a weight ratio of 7:3, a styrene-butadiene rubber (SBR) binder and a carboxymethyl cellulose (CMC) thickener in water by a weight ratio of 97:1:2.

The anode slurry was uniformly coated on an area excluding a protrusion of a copper foil (thickness: 15 μm) having the protrusion (an anode tab portion) on one side thereof, and then dried and pressed to form an anode.

An electrode assembly was formed by interposing a polyethylene separator (thickness: 20 μm) between the cathode and the anode. A cathode lead and an anode lead were welded and connected to the cathode tab and the anode tab, respectively.

The electrode assembly was accommodated in a pouch (case) such that portions of the cathode lead and the anode lead were exposed to an outside, and three sides except for an electrolyte injection side were sealed.

The electrolyte solution prepared in the above (1) was injected, the electrolyte injection side was also sealed. A lithium secondary battery sample was obtained after an impregnation for 12 hours.

TABLE 1

| | | | | | | | | | total | |
|---|---|---|---|---|---|---|---|---|---|---|
| | | | | | | | | | of | second |
| | first | | | | | | | | second | additive/ |
| | additive | second additive | | | | | | | additive | first |
| | GBL | LiPO₂F₂ | FEC | PS | PRS | ESA | VC | LiBOB | contents | additive |
| Example 1 | 2 | 0.5 | 0.5 | 0.5 | 0.25 | 0.25 | | | 2 | 1 |
| Example 2 | 2 | 1 | 0.5 | 0.5 | 0.5 | 0.5 | | | 2.5 | 1.25 |
| Example 3 | 2 | 1 | 1 | 0.5 | 0.5 | 0.5 | | | 3.5 | 1.75 |
| Example 4 | 2 | 1.5 | 1.5 | 1 | 0.5 | 0.5 | | | 5 | 2.5 |
| Example 5 | 2 | 1.5 | 1.5 | 1 | 1 | 0.5 | | | 5.5 | 2.75 |
| Example 6 | 1 | 1 | 1 | 0.5 | 0.5 | 0.5 | | | 3.5 | 3.5 |
| Example 7 | 0.5 | 1 | 1 | 0.5 | 0.5 | 0.5 | | | 3.5 | 7 |
| Example 8 | 4 | 1 | 1 | 0.5 | 0.5 | 0.5 | | | 3.5 | 0.86 |
| Example 9 | 5 | 1 | 1 | 0.5 | 0.5 | 0.5 | | | 3.5 | 0.7 |
| Example 10 | 6 | 1 | 1 | 0.5 | 0.5 | 0.5 | | | 3.5 | 0.58 |
| Example 11 | 7 | 1 | 1 | 0.5 | 0.5 | 0.5 | | | 3.5 | 0.5 |
| Comparative | | 1 | 1 | 0.5 | 0.5 | 0.5 | | | 3.5 | |
| Example 1 | | | | | | | | | | |
| Comparative | 2 | | | 0.5 | | | | | 0.5 | 0.25 |
| Example 2 | | | | | | | | | | |
| Comparative | 2 | 0.5 | 0.5 | | | | | | 1 | 0.5 |
| Example 3 | | | | | | | | | | |
| Comparative | 2 | 1 | 1 | | | | | | 2 | 1 |
| Example 4 | | | | | | | | | | |
| Comparative | 2 | 1.5 | 1.5 | | | | | | 3 | 1.5 |
| Example 5 | | | | | | | | | | |
| Comparative | 2 | 2 | 2 | | | | | | 4 | 2 |
| Example 6 | | | | | | | | | | |
| Comparative | 2 | 1 | 1 | 0.5 | 0.5 | | 0.5 | | 3.5 | 1.75 |
| Example 7 | | | | | | | | | | |
| Comparative | 2 | 1 | 1 | 0.5 | 0.5 | | | 0.5 | 3.5 | 1.75 |
| Example 8 | | | | | | | | | | |

Components shown in Table 1 are as follows.

GBL: Gamma-Butyrolactone

LiPO₂F₂: lithium difluorophosphate

FEC: fluoro ethylene carbonate

PS: 1,3-propane sultone

PRS: 1,3-propene sultone

ESA: ethylene sulfate

VC: vinylene carbonate

LiBOB: lithium bis(oxalate) borate

### Experimental Example: Evaluation on High Temperature (60° C.) Storage Properties

(1) Measuring Increasing Ratio of Battery Thickness

The secondary batteries of Examples and Comparative Example were charged (0.5 C CC/CV; 4.2V, 0.05 C cut-off) and a battery thickness T1 was measured.

The charged lithium secondary batteries of Examples and Comparative Examples were left to be exposed to an air at 60° C. for 3 weeks (using a constant temperature device), further left at room temperature for 30 minutes, and a battery thickness T2 was measured.

The battery thicknesses were measured using a plate thickness measuring device (Mitutoyo, 543-490B). An increasing ratio of a battery thickness was calculated as follows.

Increasing ratio of thickness=(T2-T1)/T1×100(%)

(2) Measuring Internal Resistance (DC-IR) Increasing Ratio

The lithium secondary batteries were charged (0.5 C CC/CV; 4.2V, 0.05 C cut-off), and 0.5 C CC-discharged to SOC 60.

At an SOC 60 point, C-rate was changed to 0.2 C, 0.5 C, 1.0 C, 1.5 C, 2.0 C, 2.5 C and 3.0 C, and discharging and recharging were performed for 10 seconds to measure a DCIR R₁.

The charged lithium secondary batteries of Examples and Comparative Examples were left to be exposed to an air at 60° C. for 3 weeks, further left at room temperature for 30 minutes, and a DCIR R₂ was measured by the above-described method.

An increasing ratio of the internal resistance was calculated as follows.

Increasing ratio of internal resistance=(R2-R1)/R1×100(%)

(3) Measuring Capacity Retention (Ret)

The secondary batteries of Examples and Comparative Example were charged (0.5 C CC/CV; 4.2V, 0.05 C cut-off) and discharged (0.5 C CC 2.7V cut-off) three times. A discharge capacity C1 at the third cycle was measured.

The secondary batteries of Examples and Comparative Example were charged (0.5 C CC/CV; 4.2V, 0.05 C cut-off). The charged lithium secondary batteries of Examples and Comparative Examples were stored at 60° C. for 3 weeks, further left at room temperature for 30 minutes, and discharged (0.5 C CC 2.75V cut-off) to measure a discharge capacity C2.

A capacity retention was calculated as follows.

Capacity retention (%)=C2/C1×100(%)

The results are shown in Table 2 below.

TABLE 2

| | increasing ratio of | increasing ratio | |
|---|---|---|---|
| | battery thickness (%) | of DCIR (%) | Ret (%) |
| Example 1 | 11 | 15.6 | 91 |
| Example 2 | 1 | 1.6 | 92 |
| Example 3 | 2 | 16.1 | 93 |
| Example 4 | 3 | 15.6 | 92 |
| Example 5 | 3 | 35.6 | 90 |
| Example 6 | 4 | 9.2 | 91 |
| Example 7 | 5 | 10.8 | 90 |
| Example 8 | 6 | 26.9 | 92 |
| Example 9 | 8 | 15.7 | 91 |
| Example 10 | 8 | 17.7 | 91 |
| Example 11 | 9 | 21.3 | 89 |
| Comparative | 16 | 6.8 | 88 |
| Example 1 | | | |
| Comparative | 42 | 25.5 | 79 |
| Example 2 | | | |
| Comparative | 34 | 32.8 | 81 |
| Example 3 | | | |
| Comparative | 13 | 23.7 | 83 |
| Example 4 | | | |
| Comparative | 13 | 23.4 | 82 |
| Example 5 | | | |
| Comparative | 38 | 29.9 | 81 |
| Example 6 | | | |
| Comparative | 13 | 2.8 | 90 |
| Example 7 | | | |
| Comparative | 11 | 9.7 | 90 |
| Example 8 | | | |

As evidenced in Table 2, the lithium secondary batteries of Examples provided improved results of the high-temperature storage evaluation (the increasing ratio of the battery thickness and the internal resistance and the capacity retention).

For example, it is predicted that a gas generation can be suppressed using the lithium secondary batteries of Examples.

For example, within a specific range of the content of the second additive in the electrolyte (e.g., 5 wt % or less), the increase of the internal resistance increase rate was effectively suppressed.

For example, within a specific range of the ratio of the eight of the second additive relative to the weight of the first additive in the electrolytic solution (e.g., 1 or more), the reduction of the thickness increase ratio and the resistance increase ratio was more effectively achieved.

What is claimed is:

1. An electrolyte solution for a lithium secondary battery, comprising:
a lithium salt;
an organic solvent;
a first additive comprising a lactone-based compound represented by Chemical Formula 1; and
a second additive comprising a fluorine-containing phosphate-based compound, a fluorine-containing carbonate-based compound, a sultone-based compound and a sulfate-based compound: 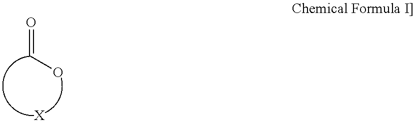
wherein, in Chemical Formula 1, X is a substituted or unsubstituted C2-C5 alkylene group.

2. The electrolyte solution for a lithium secondary battery of claim 1, wherein the lactone-based compound comprises γ-butyrolactone.

3. The electrolyte solution for a lithium secondary battery of claim 1, wherein the first additive is included in an amount from 0.1 wt % to 10 wt % based on a total weight of the electrolyte solution.

4. The electrolyte solution for a lithium secondary battery of claim 1, wherein the second additive is included in an amount from 0.1 wt % to 10 wt % based on a total weight of the electrolyte solution.

5. The electrolyte solution for a lithium secondary battery of claim 1, wherein a ratio of a weight of the second additive relative to a weight of the first additive in the electrolyte solution is from 1 to 10.

6. The electrolyte solution for a lithium secondary battery of claim 1, wherein the first additive is included in an amount from 0.5 wt % to 3.5 wt % based on a total weight of the electrolyte solution,
the second additive is included in an amount from 1 wt % to 5 wt % based on the total weight of the electrolyte solution, and
a ratio of a weight of the second additive relative to a weight of the first additive in the electrolyte solution is from 1.25 to 7.

7. The electrolyte solution for a lithium secondary battery of claim 1, wherein the fluorine-containing carbonate-based compound has a cyclic structure.

8. The electrolyte solution for a lithium secondary battery of claim 1, wherein the sultone-based compound comprises an alkyl sultone-based compound and an alkenyl sultone-based compound.

9. The electrolyte solution for a lithium secondary battery of claim 1, wherein the sulfate-based compound has a cyclic structure.

10. The electrolyte solution for a lithium secondary battery of claim 1, wherein the fluorine-containing phosphate-based compound is included in an amount from 0.1 wt % to 1.5 wt % based on a total weight of the electrolyte solution,
the fluorine-containing carbonate-based compound is included in an amount from 0.1 wt % to 1.5 wt % based on the total weight of the electrolyte solution,
the sultone-based compound is included in an amount from 0.1 wt % to 2 wt % based on the total weight of the electrolyte solution, and
the sulfate-based compound is included in an amount of 0.1 to 0.5% by weight based on the total weight of the electrolyte, an electrolyte for a lithium secondary battery:

11. The electrolyte solution for a lithium secondary battery of claim 1, wherein the organic solvent comprises a cyclic carbonate-based solvent and a linear carbonate-based solvent.

12. A lithium secondary battery, comprising:
a cathode;
an anode facing the cathode; and
the electrolyte solution for a lithium secondary battery of claim 1.
